SEQUENCE LISTING (9 sequences)

SEQ ID NO: 1 - protein, 4 aa, Artificial Sequence
  Peptide aldehyde
LGAY

SEQ ID NO: 2 - protein, 4 aa, Artificial Sequence
  Peptide aldehyde
FGAY

SEQ ID NO: 3 - protein, 4 aa, Artificial Sequence
  Peptide aldehyde
YGAY

SEQ ID NO: 4 - protein, 4 aa, Artificial Sequence
  Peptide aldehyde
FGAL

SEQ ID NO: 5 - protein, 4 aa, Artificial Sequence
  Peptide aldehyde
FGAF

SEQ ID NO: 6 - protein, 4 aa, Artificial Sequence
  Peptide aldehyde
FGVY

SEQ ID NO: 7 - protein, 4 aa, Artificial Sequence
  Peptide aldehyde
FGAM

SEQ ID NO: 8 - protein, 4 aa, Artificial Sequence
  Peptide aldehyde
WLVY

SEQ ID NO: 9 - protein, 4 aa, Artificial Sequence
  Peptide aldehyde
LGAL

(19) United States
(12) Patent Application Publication
(10) Pub. No.: US 2014/0228274 A1
(43) Pub. Date: Aug. 14, 2014

(54) Liquid Detergent Composition

(71) Applicant: Lise Munch Mikkelsen, Roedovre (DK)

(72) Inventor: Lise Munch Mikkelsen, Roedovre (DK)

(73) Assignee: Novozymes A/S, Bagsvaerd (DK)

(21) Appl. No.: 14/130,212

(22) PCT Filed: Jun. 29, 2012
(86) PCT No.: PCT/EP2012/062759

§ 371 Date: Mar. 27, 2014

Related U.S. Application Data
(60) Provisional application No. 61/503,755, filed on Jul. 1, 2011.

(30) Foreign Application Priority Data
Jul. 1, 2011 (EP) 11172409.2

(51) Int. Cl. C11D 3/386

(52) U.S. Cl. CPC C11D 3/38663; C11D 3/38636
USPC 510/393

(57) ABSTRACT

In a liquid detergent comprising a subtilisin and optionally a second (non-subtilisin) enzyme, the combination of a peptide aldehyde (or hydrosulfite adduct thereof) with a salt of a monovalent cation and a monovalent organic anion has a synergistic stabilizing effect on the subtilisin and/or the second enzyme. The improved enzyme stability is of particular interest in liquid detergent compositions where the enzyme would otherwise have poor storage stability.

### REFERENCE TO A SEQUENCE LISTING

This application contains a Sequence Listing in computer readable form.

### FIELD OF THE INVENTION

The present invention relates to the stabilization of a subtilisin in a liquid detergent.

### BACKGROUND OF THE INVENTION

When formulating a liquid detergent, it is common to include a subtilisin-type protease in order to improve the removal of protein soiling. A second, non-subtilisin enzyme (such as an amylase or a lipase) may also be included to improve the detergency towards other soilings. The storage stability of the subtilisin and of the second enzyme (if present) can be a problem, and the prior art discloses various solutions.

Various boron compounds are well known as stabilizers for subtilisins in liquid detergents, e.g., WO 96/41859. However, there is a beginning trend towards boron-free detergents since boric acid, following the recent EU REACH classification of boric acid as reprotoxic.

WO 2007/141736, WO 2007/145963 and WO 2009/118375 disclose that a peptide aldehyde can be used to stabilize the subtilisin and any second enzyme. WO 98/13459 discloses that the combination of a peptide aldehyde and calcium ions acts to provide synergistic protease inhibitor benefits.

However, high levels of calcium ions may cause problems in the formulation of liquid detergents due to complexations with builders and surfactants and might reduce the effectiveness of the incorporated builder system during wash and might reduce lathering by complexing to soaps forming white precipitate known as soap scum.

### SUMMARY OF THE INVENTION

The inventors have found that the combination of a peptide aldehyde (or hydrosulfite adduct) protease inhibitor with a salt of a monovalent cation and a monovalent organic anion has a synergistic enzyme stabilizing effect in a liquid detergent comprising a subtilisin and optionally a second (non-subtilisin) enzyme. This is of particular interest in dilute liquid detergents or in liquid detergents where the most abundant anionic surfactant are the cheaper linear or branched alkylbenzene sulfonate (LAS or BABS), and/or alkyl sulfates (AS), as enzyme stability in such detergents may be challenging, and in some cases too low stability of enzymes may prevent soapers from taking advantage of the cleaning power of enzymes.

Accordingly, the invention provides a boron-free liquid detergent composition comprising
a) a linear alkyl benzene sulfonate, (LAS)
b) a subtilisin,
c) a subtilisin inhibitor which is a peptide aldehyde or a hydrosulfite adduct thereof,
d) a salt of a monovalent cation and a monovalent organic anion of 1-6 carbons, and
e) at least 10% (w/w) of water;
   which has a total content of linear alkyl benzene sulfonate and branched alkyl benzene sulfonate (LAS and BABS) and alkyl sulfate (AS) which is larger than the total content of alkyl ethoxy ether sulfate (AES) and methyl ester sulfonate (MES).

### DETAILED DESCRIPTION OF THE INVENTION

### Subtilisin

Subtilisins is a sub-group of serine proteases. A serine protease is an enzyme which catalyzes the hydrolysis of peptide bonds, and in which there is an essential serine residue at the active site (White, Handler and Smith, 1973 “Principles of Biochemistry,” Fifth Edition, McGraw-Hill Book Company, NY, pp. 271-272). Subtilisins include, preferably consist of, the I-S1 and I-S2 sub-groups as defined by Siezen et al., Protein Engng. 4 (1991) 719-737; and Siezen et al., Protein Science 6 (1997) 501-523. Because of the highly conserved structure of the active site of serine proteases, the subtilisin according to the invention may be functionally equivalent to the proposed sub-group designated subtilase by Siezen et al. (supra).

The subtilisin may be of animal, vegetable or microbial origin, including chemically or genetically modified mutants (protein engineered variants). It may be a serine protease, preferably an alkaline microbial protease. Examples of subtilisins are those derived from Bacillus, e.g., subtilisin Novo, subtilisin Carlsberg, subtilisin BPN′, subtilisin 309, subtilisin 147 and subtilisin 168 (described in WO 89/06279) and Protease PD138 (WO 93/18140). Examples are described in WO 98/020115, WO 01/44452, WO 01/58275, WO 01/58276, WO 03/006602 and WO 04/099401. Examples of trypsin-like proteases are trypsin (e.g., of porcine or bovine origin) and the Fusarium protease described in WO89/06270 and WO94/25583. Other examples are the variants described in WO 92/19729, WO 88/08028, WO 98/20115, WO 98/20116, WO 98/34946, WO 2000/037599, WO 2011/036263 and mixtures of proteases.

Examples of commercially available subtilisins include Kannase™, Everlase™, Relase™, Esperase™, Alcalase™, Durazym™, Savinase™, Ovozyme™, Liquanase™, Coronase™, Polarzyme™, Pyrase™, Pancreatic Trypsin NOVO (PTN), Bio-Feed™ Pro and Clear-Lens™ Pro; Blaze (all available from Novozymes NS, Bagsvaerd, Denmark). Other commercially available proteases include Ronozyme™ Pro, Maxatase™, Maxacal™, Maxapem™, Opticlean™, Properase™, Purafast™, Purafect™, Purafect Ox™, Purafact Prime™, Excellase™, FN2™, FN3™ and FN4™ (available from Genencor International Inc., Gist-Brocades, BASF, or DSM). Other examples are Primase™ and Duralase™. Blap R, Blap S and Blap X available from Henkel are also examples.

### Second Enzyme

In addition to the subtilisin, the detergent composition may optionally comprise a second enzyme such as a lipase, a cutinase, an amylase, a carbohydrase, a cellulase, a pectinase, a pectate lyase, a mannanase, an arabinase, a galactanase, a xylanase, an oxidase, a laccase, and/or peroxidase. The liquid detergent may contain one, two or more non-subtilisin enzymes.

### Lipase and Cutinase

Suitable lipases and cutinases include those of bacterial or fungal origin. Chemically modified or protein engineered mutants are included. Examples include lipase from Thermomyces, e.g., from T. lanuginosus (previously named Humicola lanuginosa) as described in EP 258 068 and EP 305 216, cutinase from Humicola, e.g. H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al., 1993, Biochemica et Biophysica Acta, 1131: 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079, WO 97/07202, WO 00/060063, WO2007/087508 and WO 2009/109500.

Preferred commercially available lipase enzymes include Lipolase™, Lipolase Ultra™, and Lipex™; Lecitase™, Lipolex™; Lipoclean™, Lipoprime™ (Novozymes NS). Other commercially available lipases include Lumafast (Genencor Int Inc); Lipomax (Gist-Brocades/Genencor Int Inc) and Bacillus sp. lipase from Solvay.

### Amylase

Suitable amylases (α and/or β) include those of bacterial or fungal origin. Chemically modified or protein engineered mutants are included. Amylases include, for example, α-amylases obtained from Bacillus, e.g., a special strain of Bacillus licheniformis, described in more detail in GB 1,296,839.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

Commercially available amylases are Stainzyme; Stainzyme Plus; Duramyl™, Termamyl™, Termamyl Ultra; Natalase, Fungamyl™ and BAN™ (Novozymes NS), Rapidase™ and Purastar™ (from Genencor International Inc.).

### Lyases

The lyase may be a pectate lyase derived from Bacillus, particularly B. lichemiformis or B. agaradhaerens, or a variant derived of any of these, e.g., as described in U.S. Pat. No. 6,124,127, WO 1999/027083, WO 1999/027084, WO 2002/006442, WO 2002/092741, WO 2003/095638, A commercially available pectate lyase is XPect; Pectawash and Pectaway (Novozymes NS).

### Mannanase

The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 1999/064619. A commercially available mannanase is Mannaway (Novozymes NS).

### Cellulase

Suitable cellulases may be of bacterial or fungal origin. Chemically or genetically modified mutants are included. It may be a fungal cellulase from Humicola insolens (U.S. Pat. No. 4,435,307) or from Trichoderma, e.g., T. reesei or T. viride. Examples of cellulases are described in EP 0 495 257. Commercially available cellulases include Carezyme™, Celluzyme™, Celluclean™, Celluclast™, and Endolase™; Renozyme; Whitezyme (Novozymes NS) Puradax, Puradax HA, and Puradax EG (available from Genencor).

### Peptide Aldehyde (Hydrosulfite) Inhibitor

### Peptide Aldehyde

The peptide aldehyde may have the formula X—B¹—B⁰—H wherein the groups are defined as above with B⁰ being a single amino acid residue with L- or D-configuration with the formula: NH—CHR—CO.

The peptide aldehyde may have the formula X—B¹—B⁰—H, wherein the groups have the following meaning:
a) H is hydrogen;
b) B⁰ is a single amino acid residue with L- or D-configuration;
c) B¹ is a single amino acid residue; and
d) X consists of one or more amino acid residues (preferably one or two), optionally comprising an N-terminal protection group.

NH—CHR—CO (B⁰) is an L or D-amino acid residue, where R may be an aliphatic or aromatic side chain, e.g. aralkyl, such as benzyl, where R may be optionally substituted. More particularly, the B⁰ residue may be bulky, neutral, polar, hydrophobic and/or aromatic. Examples are the D- or L-form of Tyr (p-tyrosine), m-tyrosine, 3,4-dihydroxyphenylalanine, Phe, Val, Met, norvaline (Nva), Leu, Ile or norleucine (Nle).

In the above formula, X—B¹—B⁰—H, the B¹ residue may particularly be small, aliphatic, hydrophobic and/or neutral. Examples are alanine (Ala), cysteine (Cys), glycine (Gly), proline (Pro), serine (Ser), threonine (Thr), valine (Val), norvaline (Nva) and norleucine (Nle), particularly alanine, glycine, or valine.

X may in particular be one or two amino acid residues with an optional N-terminal protection group (i.e. the compound is a tri- or tetrapeptide aldehyde with or without a protection group). Thus, X may be B², B³—B², Z—B², or Z—B³—B² where B³ and B² each represents one amino acid residue, and Z is an N-terminal protection group. The B² residue may in particular be small, aliphatic and/or neutral, e.g., Ala, Gly, Thr, Arg, Leu, Phe or Val. The B³ residue may in particular be bulky, hydrophobic, neutral and/or aromatic, e.g., Phe, Tyr, Trp, Phenylglycine, Leu, Val, Nva, Nle or Ile.

The N-terminal protection group Z (if present) may be selected from formyl, acetyl, benzoyl, trifluoroacetyl, fluoromethoxy carbonyl, methoxysuccinyl, aromatic and aliphatic urethane protecting groups, benzyloxycarbonyl (Cbz), t-butyloxycarbonyl, adamantyloxycarbonyl, p-methoxybenzyl carbonyl (MOZ), benzyl (Bn), p-methoxybenzyl (PMB) or p-methoxyphenyl (PMP), methoxycarbonyl (Moc); methoxyacetyl (Mac); methyl carbamate or a methylamino carbonyl/methyl urea group. In the case of a tripeptide aldehyde with a protection group (i.e. X═Z—B²), Z is preferably a small aliphatic group, e.g., formyl, acetyl, fluoromethoxy carbonyl, t-butyloxycarbonyl, methoxycarbonyl (Moc); methoxyacetyl (Mac); methyl carbamate or a Methylamino carbonyl/methyl urea group. In the case of a tripeptide aldehyde with a protection group (i.e. X═Z—B³—B²), Z is preferably a bulky aromatic group such as benzoyl, benzyloxycarbonyl, p-methoxybenzyl carbonyl (MOZ), benzyl (Bn), p-methoxybenzyl (PMB) or p-methoxyphenyl (PMP).

Suitable peptide aldehydes are described in WO 94/04651, WO 95/25791, WO 98/13458, WO 98/13459, WO 98/13460, WO 98/13461, WO 98/13461, WO 98/13462, WO 2007/141736, 2007/145963, WO 2009/118375, WO 2010/055052 and WO 2011/036153. More particularly, the peptide aldehyde may be Cbz-RAY-H, Ac-GAY-H, Cbz-GAY-H, Cbz-GAL-H, Cbz-VAL-H, Cbz-GAF-H, Cbz-GAV-H, Cbz-GGY-H, Cbz-GGF-H, Cbz-RVY-H, Cbz-LVY-H, Ac-LGAY-H, Ac-FGAY-H, Ac-YGAY-H, Ac-FGAL-H, Ac-FGAF-H, Ac-FGVY-H, Ac-FGAM-H, Ac-WLVY-H, MeO—CO-VAL-H, MeNCO-VAL-H, MeO—CO-FGAL-H, MeO—CO-FGAF-H, MeSO₂-FGAL-H, MeSO₂-VAL-H, PhCH₂O(OH)(O)P-VAL-H, EtSO₂-FGAL-H, PhCH₂SO₂-VAL-H, PhCH₂O(OH)(O)P-LAL-H, PhCH₂O(OH)(O)P-FAL-H, or MeO(OH)(O)P-LGAL-H. Here, Cbz is benzyloxycarbonyl, Me is methyl, Et is ethyl, Ac is acetyl, H is hydrogen, and the other letters represent amino acid residues denoted by standard single letter notification (e.g., F=Phe, Y=Tyr, L=Leu).

Alternatively, the peptide aldehyde may have the formula as described in WO 2011/036153:

P—O-(Aᵢ-X′)ₙ-Aₙ₊₁-Q

wherein Q is hydrogen, CH₃, CX₃, CHX₂, or CH₂X, wherein X is a halogen atom;

wherein one X′ is the “double N-capping group” CO, CO—CO, CS, CS—CS or CS—CO, most preferred undo (CO), and the other X′ es are nothing,

wherein n=1-10, preferably 2-5, most preferably 2,

wherein each of Aᵢ and Aₙ₊₁ is an amino acid residue having the structure:

—NH—CR—CO— for a residue to the right of X═—CO—, or

—CO—CR—NH— for a residue to the left of X=—CO—

wherein R is H— or an optionally substituted alkyl or alkylaryl group which may optionally include a hetero atom and may optionally be linked to the N atom, and

wherein P is hydrogen or any C-terminal protection group.

Examples of such peptide aldehydes include α-MAPI, β-MAPI, F-urea-RVY-H, F-urea-GGY-H, F-urea-GAF-H, F-urea-GAY-H, F-urea-GAL-H, F-urea-GA-Nva-H, F-urea-GA-Nle-H, Y-urea-RVY-H, Y-urea-GAY-H, F-CS-RVF-H, F-CS-RVY-H, F-CS-GAY-H, Antipain, GE20372A, GE20372B, Chymostatin A, Chymostatin B, and Chymostatin C. Further examples of peptide aldehydes are disclosed in WO 2010/055052 and WO 2009/118375, WO 94/04651, WO 98/13459, WO 98/13461, WO 98/13462, WO 2007/145963, (P&G) hereby incorporated by reference.

### Hydrosulfite Adduct

Alternatively to a peptide aldehyde, the protease inhibitor may be a hydrosulfite adduct having the formula X—B¹—NH—CHR—CHOH—SO₃M, wherein X, B¹ and R are defined as above, and M is H or an alkali metal, preferably Na or K.

The peptide aldehyde may be converted into a water-soluble hydrosulfite adduct by reaction with sodium bisulfite, as described in textbooks, e.g. March, J. Advanced Organic Chemistry, fourth edition, Wiley-Interscience, US 1992, p 895.

An aqueous solution of the bisulfite adduct may be prepared by reacting the corresponding peptide aldehyde with an aqueous solution of sodium bisulfite (sodium hydrogen sulfite, NaHSO₃); potassium bisulfite (KHSO₃) by known methods, e.g., as described in WO 98/47523; U.S. Pat. No. 6,500,802; U.S. Pat. No. 5,436,229; J. Am. Chem. Soc. (1978) 100, 1228; Org. Synth., Coll. vol. 7: 361.

### Salt

The salt used in the liquid detergent is a salt of a monovalent cation and a monovalent organic anion of 1-6 carbons. Preferably, the monovalent organic anion is a small monocarboxylic acid of 1-6 carbons. The monovalent organic anion is preferably selected among formate, acetate, propionate and lactate. The cation may be Na⁺, K⁺ or NH₄⁺, and the salt may in particular be sodium formate.

### Amounts

The subtilisin and the optional second enzyme may each be present in the liquid detergent in an amount in the range from 0.0001% (w/w) to 5% (w/w). Typical amounts are in the range from 0.01% to 2% by weight of the liquid detergent composition.

The molar ratio of the peptide aldehyde (or hydrosulfite adduct) to the protease may be at least 1:1 or 1.5:1, and it may be less than 1000:1, more preferred less than 500:1, even more preferred from 100:1 to 2:1 or from 20:1 to 2:1, or most preferred, the molar ratio is from 10:1 to 2:1.

The salt may be present in the liquid detergent in an amount of at least 0.1% w/w or 0.5% w/w, e.g., at least 1.0%, at least 1.2% or at least 1.5%. The amount of the salt is typically below 5% w/w, below 4% or below 3%.

### Detergent Composition

The liquid detergent has a physical form, which is not solid (or gas). It may be a pourable liquid, a pourable gel or a non-pourable gel. It may be either isotropic or structured, preferably isotropic. It may be a formulation useful for washing in automatic washing machines or for hand washing.

Detergent ingredients can be separated physically from each other by compartments in water dissolvable pouches. Thereby negative storage interaction between components can be avoided. Different dissolution profiles of each of the compartments can also give rise to delayed dissolution of selected components in the wash solution.

The detergent composition may take the form of a unit dose product. A unit dose product is the packaging of a single dose in a non-reusable container. It is increasingly used in detergents for laundry and dish wash. A detergent unit dose product is the packaging (e.g., in a pouch made from a water soluble film) of the amount of detergent used for a single wash.

Pouches can be of any form, shape and material which is suitable for holding the composition, e.g., without allowing the release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be a blend compositions comprising hydrolytically degradable and water soluble polymer blends such as polyactide and polyvinyl alcohol (known under the Trade reference M8630 as sold by Chris Craft In. Prod. Of Gary, Ind., US) plus plasticizers like glycerol, ethylene glycerol, Propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids (see e.g., US 2009/0011970).

The choice of detergent components may include, for textile care, the consideration of the type of textile to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the skilled artisan.

### Surfactants

In this specification, anionic surfactants are grouped into a first group which tends to have a harmful effect on enzyme stability (subtilisin and the optional second enzyme) and a second group which tends to have a less harmful effect on the stability of these enzymes. The liquid detergent has a total content of surfactants in the first (harmful) group which is larger than the total content of the second (less harmful) group. Thus, the invention relates to improving enzyme stability in liquid detergents where the surfactant formulation would otherwise result in fairly poor enzyme stability.

The first group consists of linear and branched alkyl benzene sulfonate, (LAS and BABS) and alkyl sulfate (AS) The second group includes alkyl ethoxy ether sulfate (AES) and methyl ester sulfonate (MES).

The first group also includes isomers of LAS and branched alkylbenzenesulfonates (BABS) and phenylalkanesulfonates. Alkyl sulfate (AS) may include sodium dodecyl sulfate (SDS) or fatty alcohol sulfates (FAS), primary alcohol sulfates (PAS).

In the second group; alcohol ethersulfates (AES) is also known as alcohol ethoxysulfates (AEOS) or fatty alcohol ether sulfates (FES), including sodium lauryl ether sulfate (SLES). Alpha-sulfo fatty acid methyl esters (MEA, alpha-SFMe or SES).

The liquid detergent contains LAS, e.g., in an amount of 1-30% by weight, for example from about 1-15%; and it may contain surfactants of the first group in an amount of 1-50% by weight, for example 2-30% and it may contain surfactants of the second group in an amount lower than the amount of the first group, for example 1-25% by weight.

The liquid detergent may furthermore contain other anionic surfactants such as soaps and or fatty acids, alpha-olefin sulfonate (AOS), dodecenyl/tetradecenyl succinic acid (DTSA), fatty acid derivatives of amino acids, diesters and monoesters of sulfo-succinic acid or soap, and combinations thereof.

The liquid detergent may also contain non-ionic surfactants such as alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamide (PFAM), polyhydroxy alkyl fatty acid amides, methylester ethoxylates, polyethylated polyoxypropylene glycols; sorbitol esters, polyoxyethylenated sorbitol esters, alkanolamides, N-alkylpyrrolidones (WO2007141736) or N-acyl N-alkyl derivatives of glucosamine (glucamides, GA, or fatty acid glucamide, FAGA), as well as products available under the trade names SPAN and TWEEN, and combinations thereof.

When included therein the detergent will usually contain from about 0.1% to about 70% by weight of a non-ionic surfactant, for example from about 0.5% to about 30%, in particular from about 1% to about 20%, from about 2% to about 15%; or from 30-60%.

### Optional Additional Enzyme Stabilizers

Optionally, the liquid detergent may comprise an additional enzyme stabilizer, e.g., a polyol such as propylene glycol (MPG), sorbitol or glycerol, e.g., in an amount of 0.5-10% w/w.

### Solvents

Optionally the detergent may contain 0-10% ethanol; or such as 0-5% ethanol on top of any polyols optionally present. The aqueous liquid detergent may contain from 0-30% organic solvent including EtOH and polyols.

### Builders and Buffer Systems

The liquid detergent may comprise a builder such as sodium citrate or citric acid, e.g., in an amount of 0-5% w/w, such as about 0.1-2%. Other buffering systems may include alcanol amines such as Mono- di- or Triethanol amine (MEA, DEA or TEA) in the levels 0.1-5%.

pH

The pH of the liquid detergent may be in the range 6.0-10; particularly between 6.5-9.5; or between 7-9. pH may be measured directly in the detergent or in a 5% solution in water.

### Other Ingredients

The liquid detergent may also contain minors, such as polymers, viscosity controlling agents (for example, NaCl or polymers); preservatives, dye transfer inhibitors, perfumes; opacifiers; fabric huing agents; and antifoam agents.

The liquid detergent is essentially free of boron compounds and has low levels of calcium. Thus, the boron content is below 500 ppm B (by weight), and the calcium content may be below 500 ppm (Ca).

### Water Content

The liquid detergent is aqueous, containing at least 10% by weight and up to 95% water, such as 20-90% water, 40-80% water; or at least (above) 50% water.

### Liquid Detergent Composition

In a first aspect, the present invention provides a boron-free liquid detergent composition, comprising:
a) a linear alkyl benzene sulfonate, (LAS)
b) a subtilisin,
c) a subtilisin inhibitor which is a peptide aldehyde or a hydrosulfite adduct thereof,
d) a salt of a monovalent cation and a monovalent organic anion of 1-6 carbons, and
e) at least 10% water;
   which has a total content of linear alkyl benzene sulfonate and branched alkyl benzene sulfonate (LAS and BABS) and alkyl sulfate (AS) which is larger than the total content of alkyl ethoxy ether sulfate (AES) and methyl ester sulfonate (MES).

In a embodiment, the inhibitor is a peptide aldehyde of the formula X—B¹—B⁰—H or a hydrosulfite adduct thereof, wherein:
a) H is hydrogen;
b) B⁰ is a single D- or L-amino acid residue;
c) B¹ is a single amino acid residue; and
d) X consists of one or more amino acid residues (preferably one or two), optionally comprising an N-terminal protection group.

Preferably, B⁰ is an L or D-amino acid residue of Tyr, m-tyrosine, 3,4-dihydroxyphenylalanine, Phe, Val, Met, Nva, Leu, Ile or Nle.

Preferably, B¹ is a residue with a small optionally substituted aliphatic side chain, preferably Ala, Cys, Gly, Pro, Ser, Thr, Val, Nva, or Nle.

Preferably, X is B², B³—B², Z—B², Z—B³—B², wherein B² and B³ each represents one amino acid residue, and Z is an N-terminal protection group.

Preferably, B² is a single residue of Val, Gly, Ala, Arg, Leu, Phe or Thr.

Preferably, B³ is Phe, Tyr, Trp, Phenylglycine, Leu, Val, Nva, Nle or Ile.

More preferably, the inhibitor is one of the following peptide aldehydes or a hydrosulfite adduct thereof: Cbz-RAY-H, Ac-GAY-H, Cbz-GAY-H, Cbz-GAL-H, Cbz-VAL-H, Cbz-GAF-H, Cbz-GAV-H, Cbz-GGY-H, Cbz-GGF-H, Cbz-RVY-H, Cbz-LVY-H, Ac-LGAY-H, Ac-FGAY-H, Ac-YGAY-H, Ac-FGAL-H, Ac-FGAF-H, Ac-FGVY-H, Ac-FGAM-H, Ac-WLVY-H, MeO—CO-VAL-H, MeNCO-VAL-H, MeO—CO-FGAL-H, MeO—CO-FGAF-H, MeSO₂-FGAL-H, MeSO₂-VAL-H, PhCH₂O(OH)(O)P-VAL-H, EtSO₂-FGAL-H, PhCH₂SO₂-VAL-H, PhCH₂O(OH)(O)P-LAL-H, PhCH₂O(OH)(O)P-FAL-H, MeO(OH)(O)P-LGAL-H, α-MAPI, β-MAPI, F-urea-RVY-H, F-urea-GGY-H, F-urea-GAF-H, F-urea-GAY-H, F-urea-GAL-H, F-urea-GA-Nva-H, F-urea-GA-Nle-H, Y-urea-RVY-H, Y-urea-GAY-H, F-CS-RVF-H, F-CS-RVY-H, F-CS-GAY-H, Antipain, GE20372A, GE20372B, Chymostatin A, Chymostatin B, or Chymostatin C.

In an embodiment, the monovalent organic anion is formate, acetate, propionate or lactate; preferably formate. In an embodiment, the monovalent cation is Na, K or NH₄. In a preferred embodiment, the salt is sodium formate. More preferably, the salt is present in an amount of at least 0.1% by weight of the total composition.

In an embodiment, the liquid detergent composition further comprises a second enzyme, particularly a pectate lyase, a mannanase, an amylase or a lipase.

In an embodiment, the liquid detergent composition further comprises a polyol.

In an embodiment, the liquid detergent composition comprises at least 50% by weight of water.

### EXAMPLES

General experimental details: Detergents containing Savinase 16L and either X—B¹—B⁰—H or X—B¹—NH—CHR—CHOH—SO₃Na; or Savinase 16L; are placed in closed glasses at −18° C.; 35° C. and 40° C. Residual activities of protease and lipase are measured after different times using standard analytical methods (protease by hydrolysis of N,N-dimethylcasein at 40° C., pH 8.3 and lipase by hydrolysis of pNp-valerate at 40° C., pH 7.7). The inhibitor and protease may also be added individually to the detergent.

### Example 1

### Preparation of a Stabilized Subtilisin Formulation Comprising Subtilisin and Peptide Aldehyde or a Peptide Aldehyde Hydrosulfite Adduct

To a commercially available Savinase 16L™ (Novozymes NS, Bagsvaerd, Denmark) is added 0.75% X—B¹—B⁰—H or 0.9% X—B¹—NH—CHR—CHOH—SO₃Na. The inhibitor is added either as a solid or as a liquid solution. Preferred examples include X=Cbz-Gly-; B¹=Ala; B⁰=Tyr; R=CH₂(C₆H₄)OH.

### Example 2

### Enzyme Stability in Liquid Detergents

As an example of liquid detergents with a stabilized subtilisin formulation, the compositions described in Table 1 were made.

TABLE 1
Detergent compositions.

| | A | B |
|---|---|---|
| Component | (% w/w) | (% w/w) |
| Sodium dodecyl benzene sulfonate | 6.0 | 6.0 |
| NaOH | 1.4 | 1.4 |
| Soy fatty acid (Edenor SJ) | 3.0 | 3.0 |
| Coco fatty acid (Radiacid 0631) | 2.5 | 2.5 |
| Primary alcohol ethoxylate (C13, 8EO) | 5.0 | 5.0 |
| Ethanol 99% | 5.0 | 5.0 |
| Monopropylene glycol | 5.0 | 5.0 |
| Tri-sodium citrate 2H₂O | 0.5 | 0.5 |
| Triethanol amine | 2.0 | 2.0 |
| Phosphonat (Dequest 2066 C2) | 3.0 | 3.0 |
| pH adjusted with additional NaOH if necessary to | 8.4 | 8.4 |
| Savinase 16L; Savinase 16L + X-B¹-B⁰-H or | 0.75 | 0.75 |
| X-B¹-NH—CHR—CHOH—SO₃M | | |
| Lipex 100L ™ (available from Novozymes A/S) | 0.15 | 0.15 |
| Stainzyme 12L ™ (available from Novozymes | 0.4 | 0.4 |
| A/S) | | |
| Mannaway 4L ™ (available from Novozymes | 0.4 | 0.4 |
| A/S) | | |
| XPect 1000L ™ (available from Novozymes | 0.25 | 0.25 |
| A/S) | | |
| Endolase 5000L ™ (available from Novozymes | 0.25 | 0.25 |
| A/S) | | |
| Na-formate | — | 2.0 |
| Water | ad 100% | ad 100% |

The detergents were stored at 35° C. and 40° C., and the residual protease and lipase activities (expressed in % of initial activity) were determined after two weeks, as shown in Table 2.

TABLE 2
Residual protease and lipase activities.

| | Inhibitor | Na formate | | Protease | Lipase |
|---|---|---|---|---|---|
| | dosage in | dosage in | | 2 weeks at | 2 weeks at |
| Inhibitor | detergent | detergent | Detergent | 40° C. | 35° C. |
| no | no | no | A | 1% | 1% |
| no | no | 2% | B | 1% | 3% |
| X-B¹-B⁰-H with X = Cbz-Val; | 21 ppm | no | A | 2% | 13% |
| B¹ = Ala; B⁰ = Leu | | | | | |
| X-B¹-B⁰-H with X = Cbz-Val; | 21 ppm | 2% | B | 49% | 30% |
| B¹ = Ala; B⁰ = Leu | | | | | |
| X-B¹-B⁰-H with X = Cbz-Gly; | 21 ppm | no | A | 5% | 16% |
| B¹ = Ala; B⁰ = Tyr | | | | | |
| X-B¹-B⁰-H with X = Cbz-Gly; | 21 ppm | 2% | B | 71% | 32% |
| B¹ = Ala; B⁰ = Tyr | | | | | |
| X-B¹- NH—CHR—CHOH—SO₃M | 26 ppm | no | A | 3% | 18% |
| with X = Cbz-Gly; B¹ = Ala; | | | | | |
| R = CH₂C₆H₄OH; M = Na | | | | | |
| X-B¹- NH—CHR—CHOH—SO₃M | 26 ppm | 2% | B | 53% | 32% |
| with X = Cbz-Gly; B¹ = Ala; | | | | | |
| R = CH₂C₆H₄OH; M = Na | | | | | |

A comparison of the first four lines shows that the residual protease/lipase activity is 1%/1% without any stabilizer. The addition of sodium formate alone improves this to 1%/3%, and the addition of the peptide aldehyde alone improves it to 2%/13%, but a combination of sodium formate and peptide aldehyde increases the residual activities to 49%/30%, clearly demonstrating a synergistic enzyme stabilizing effect. A similar synergistic effect is demonstrated in the table above for another peptide aldehyde and for a hydrosulfite adduct.

### Example 3

### Preparation of a Detergent Comprising a Stabilized Subtilisin Formulation and Surfactant System

As another example of detergents with a stabilized subtilisin formulation, the compositions described in Table 3 were made.

TABLE 3
Detergent compositions.

| | C | D | E | F |
|---|---|---|---|---|
| Component | (% w/w) | (% w/w) | (% w/w) | (% w/w) |
| Sodium dodecyl benzene sulfonate | 6.0 | 6.0 | 12.0 | 12.0 |
| NaOH | 1.4 | 1.4 | 3.0 | 3.0 |
| Soy fatty acid (Edenor SJ) | 3.0 | 3.0 | 6.0 | 6.0 |
| Coco fatty acid (Radiacid 0631) | 2.5 | 2.5 | 5.0 | 5.0 |
| Primary alcohol ethoxylate (C13, 8EO) | 5.0 | 5.0 | 10.0 | 10.0 |
| Ethanol | 5.0 | 5.0 | 5.0 | 5.0 |
| Monopropylene glycol | 5.0 | 5.0 | 5.0 | 5.0 |
| Tri-sodium citrate 2H₂O | 0.5 | 0.5 | 1.0 | 1.0 |
| Triethanol amine | 2.0 | 2.0 | 2.0 | 2.0 |
| Phosphonat - Dequest 2066 C2 | 3.0 | 3.0 | 3.0 | 3.0 |
| pH adjusted with additional NaOH if necessary to | 9.5 | 9.5 | 8.4 | 8.4 |
| Na-formate | — | 2.0 | — | 2.0 |
| Stabilized Savinase formulation with | 0.75 | 0.75 | 1.0 | 1.0 |
| X-B¹-NH—CHR—CHOH—SO₃Na; | | | | |
| or Savinase 16L for comparison | | | | |
| Lipex 100L ™ (available from Novozymes A/S) | 0.15 | 0.15 | 0.75 | 0.75 |
| Stainzyme 12L ™ (available from Novozymes A/S) | 0.4 | 0.4 | | |
| Mannaway 4L ™ (available from Novozymes A/S) | 0.4 | 0.4 | | |
| XPect 1000L ™ (available from Novozymes A/S) | 0.25 | 0.25 | | |
| Endolase 5000L ™ (available from Novozymes A/S) | 0.25 | 0.25 | | |
| Water | ad 100% | ad 100% | ad 100% | ad 100% |

The detergents were stored at 35° C., and the residual protease and lipase activities (expressed in % of initial activity) were determined after two and four weeks, as shown in Table 4.

TABLE 4
Residual protease and lipase activities.

| | Inhibitor | Na formate | | Protease | Lipase |
|---|---|---|---|---|---|
| | dosage in | dosage in | | 4 weeks at | 2 weeks at |
| Inhibitor | detergent | detergent | Detergent | 35° C. | 35° C. |
| X-B¹- NH—CHR—CHOH—SO₃M | 26 ppm | no | C | 1% | 6% |
| with X = Cbz-Gly; B¹ = Ala; | | | | | |
| R = CH₂C₆H₄OH; M = Na | | | | | |
| X-B¹- NH—CHR—CHOH—SO₃M | 26 ppm | 2% | D | 18% | 18% |
| with X = Cbz-Gly; B¹ = Ala; | | | | | |
| R = CH₂C₆H₄OH; M = Na | | | | | |
| no | no | no | E | 1% | 2% |
| X-B¹-B⁰-H with X = Cbz-Gly; | yes | no | E | 43% | 14% |
| B¹ = Ala; B⁰ = Tyr | | | | | |
| X-B¹-B⁰-H with X = Cbz-Gly; | yes | 2% | F | 88% | 27% |
| B¹ = Ala; B⁰ = Tyr | | | | | |

The data clearly demonstrate that sodium formate (salt of a monovalent organic anion and a monovalent cation) in combination with a peptide aldehyde (or hydrosulfite adduct) protease inhibitor significantly increases the enzyme stabilizing effect.

1. A boron-free liquid detergent composition, comprising
a) a linear alkyl benzene sulfonate, (LAS)
b) a subtilisin,
c) a subtilisin inhibitor which is a peptide aldehyde or a hydrosulfite adduct thereof,
d) a salt of a monovalent cation and a monovalent organic anion of 1-6 carbons, and
e) at least 10% water;
which has a total content of linear alkyl benzene sulfonate and branched alkyl benzene sulfonate (LAS and BABS) and alkyl sulfate (AS) which is larger than the total content of alkyl ethoxy ether sulfate (AES) and methyl ester sulfonate (MES).

2. The liquid detergent composition of claim 1 wherein the inhibitor is a peptide aldehyde of the formula X—B¹—B⁰—H or a hydrosulfite adduct thereof, wherein:
a) H is hydrogen;
b) B⁰ is a single D- or L-amino acid residue;
c) B¹ is a single amino acid residue; and
d) X consists of one or more amino acid residues (preferably one or two), optionally comprising an N-terminal protection group.

3. The liquid detergent composition of claim 2, wherein B⁰ is an L or D-amino acid residue of Tyr, m-tyrosine, 3,4-dihydroxyphenylalanine, Phe, Val, Met, Nva, Leu, Ile or Nle.

4. The liquid detergent composition of claim 2, wherein B¹ is a residue with a small optionally substituted aliphatic side chain, preferably Ala, Cys, Gly, Pro, Ser, Thr, Val, Nva, or Nle.

5. The liquid detergent composition of claim 2, wherein X is B², B³—B², Z—B², Z—B³—B², wherein B² and B³ each represents one amino acid residue, and Z is an N-terminal protection group.

6. The liquid detergent composition of claim 5, wherein B² is a single residue of Val, Gly, Ala, Arg, Leu, Phe or Thr.

7. The liquid detergent composition of claim 5, wherein B³ is Phe, Tyr, Trp, Phenylglycine, Leu, Val, Nva, Nle or Ile.

8. The liquid detergent composition claim 1 wherein the inhibitor is one of the following peptide aldehydes or a hydrosulfite adduct thereof: Cbz-RAY-H, Ac-GAY-H, Cbz-GAY-H, Cbz-GAL-H, Cbz-VAL-H, Cbz-GAF-H, Cbz-GAV-H, Cbz-GGY-H, Cbz-GGF-H, Cbz-RVY-H, Cbz-LVY-H, Ac-LGAY-H, Ac-FGAY-H, Ac-YGAY-H, Ac-FGAL-H, Ac-FGAF-H, Ac-FGVY-H, Ac-FGAM-H, Ac-WLVY-H, MeO—CO-VAL-H, MeNCO-VAL-H, MeO—CO-FGAL-H, MeO—CO-FGAF-H, MeSO₂-FGAL-H, MeSO₂-VAL-H, PhCH₂O(OH)(O)P-VAL-H, EtSO₂-FGAL-H, PhCH₂SO₂-VAL-H, PhCH₂O(OH)(O)P-LAL-H, PhCH₂O(OH)(O)P-FAL-H, MeO(OH)(O)P-LGAL-H, α-MAPI, β-MAPI, F-urea-RVY-H, F-urea-GGY-H, F-urea-GAF-H, F-urea-GAY-H, F-urea-GAL-H, F-urea-GA-Nva-H, F-urea-GA-Nle-H, Y-urea-RVY-H, Y-urea-GAY-H, F-CS-RVF-H, F-CS-RVY-H, F-CS-GAY-H, Antipain, GE20372A, GE20372B, Chymostatin A, Chymostatin B, or Chymostatin C.

9. The liquid detergent composition of claim 1 wherein the anion is formate, acetate, propionate or lactate; preferably formate.

10. The liquid detergent composition of claim 1 wherein the cation is Na, K or NH₄.

11. The liquid detergent composition of claim 1 wherein the salt is sodium formate.

12. The liquid detergent composition of claim 1 wherein the salt is present in an amount of at least 0.1% by weight of the total composition.

13. The liquid detergent composition of claim 1 which further comprises a second enzyme, particularly a pectate lyase, a mannanase, an amylase or a lipase.

14. The liquid detergent composition of claim 1 which further comprises a polyol.

15. The liquid detergent composition of claim 1 which comprises at least 50% by weight of water.
